(19) United States
(12) Patent Application Publication
(10) Pub. No.: US 2021/0240965 A1
(43) Pub. Date: Aug. 5, 2021

(54) SYSTEM AND METHOD FOR RETRIEVING BALES FROM A FIELD

(71) Applicant: DEERE & COMPANY, Moline, IL (US)

(72) Inventors: MILAN YADAV, Pune (IN); SATYAM NALAWADE, Pune (IN); DHANASHREE DESAI, Pune (IN); JERRY SAMUEL, Pune (IN)

(21) Appl. No.: 16/776,788

(22) Filed: Jan. 30, 2020

(51) Int. Cl. G06K 9/00; G05D 1/00; B64C 39/02; G08G 5/00

(52) U.S. Cl. CPC G06K 9/0063; G05D 1/0088; B64C 39/024; H04W 4/029; B64C 2201/123; B64C 2201/127; G08G 5/0013

(57) ABSTRACT

A bale retrieval system includes an aerial vehicle operable to fly over a field. An imaging device is mounted on the aerial vehicle. The imaging device is operable to capture an image of the field. A position locater is operable to determine a position of multiple bales located on the field. A controller is operable to identify the bales included in images captured by the imaging device, and then determine a location of each bale identified in the image with the position locator. The location of each bale may be used to generate a map showing the bales in the field. The location of the bales may then be communicated to a bale retriever for pickup.

### TECHNICAL FIELD

The disclosure generally relates to a bale retrieval system and a method of retrieving bales of crop material from a field.

### BACKGROUND

A baler implement gathers crop material from a field and forms the crop material within a baling chamber into a bale having a desired shape. The baler implement may be configured to form the crop material into a cylindrical shape, often referred to as a round bale, or may be configured to form the crop material into a rectangular parallelepiped shape, often referred to as a square bale, a small square bale, or a large square bale. Once the crop material has been formed within the baling chamber, a wrap material is wrapped around an exterior circumference of the bale to maintain the shape of the bale. The bale may then be discharged from the baling chamber, often discharged onto a ground surface of the field.

The completed bales located in the field must then be located, picked up, and moved to an aggregation site or loaded onto a transport, e.g., a trailer. In large and/or hilly fields, the completed bales may be difficult to locate or see from a cab of a traditional tractor or other similar agricultural vehicle. Additionally, if the location of the bales in the field is not known prior to retrieval, then an operator is left to simply collect the bales randomly. Such random collection may not be the most efficient sequence for collecting the bales, increasing the time and cost of collection, and increasing the soil compaction in the field due to increased travel over the field.

### SUMMARY

A bale retrieval system is provided. The bale retrieval system includes an aerial vehicle operable to fly over a field. An imaging device is mounted on the aerial vehicle. The imaging device is operable to capture an image of the field. A position locater is operable to determine a position on the field. A controller is disposed in communication with the imaging device and the position locater. The controller includes a processor and a memory having a bale mapping algorithm stored thereon. The processor is operable to execute the bale mapping algorithm to identify a bale included in an image captured by the imaging device. The controller may then determine a location of the bale identified in the image with the position locator, and communicate the location of the bale in the field to a bale retriever.

In one aspect of the disclosure, the aerial vehicle may include one of a manned aerial vehicle, an un-manned aerial vehicle, or a satellite. The manned aerial vehicle may include, but is not limited to, an airplane, a helicopter, or some similar vehicle. The un-manned aerial vehicle may include, but is not limited to, a drone, a remote controlled airplane, a remote controlled helicopter, or some other un-manned aerial vehicle. The un-manned aerial vehicle may be configured to operate autonomously within a perimeter of the field to identify and locate all bales located within the perimeter of the field. In other implementations, the aerial vehicle may be configured for manual control by an operator.

In one aspect of the disclosure, the imaging device may include a camera having lens that is positioned to face in a substantially downward vertical direction during aerial operation of the aerial vehicle. When so positioned, the imaging device is positioned to capture an image directly below the aerial vehicle.

In one aspect of the disclosure, the aerial vehicle may include a gimbal supporting the imaging device. The gimbal maintains the downward vertical direction of the imaging device regardless of the orientation of the aerial vehicle relative to a horizontal plane during movement over the field.

In one aspect of the disclosure, the position locator is mounted to the aerial vehicle. The position locator is operable to determine a location of the aerial vehicle over the field. In one implementation, the position locator is operable to determine the location of the aerial vehicle over the field at the time an image is captured by the imaging device. By so doing, the location of the aerial vehicle at the time the image is captured substantially corresponds to the position on the field. As such, if the aerial vehicle hovers over a bale located on the field and captures an image of the bale while simultaneously determining the location of the aerial vehicle over the field, the location of the aerial vehicle over the field substantially corresponds to the location of the bale in the field. In one implementation, the position locator may include a Global Positioning Satellite (GPS) system receiver that is operable to receive a location signal from multiple satellites, and use the multiple location signals to calculate a current location.

In one aspect of the disclosure, the processor is operable to execute the bale mapping algorithm to generate a map of the field. The map of the field indicates the location of the bale in the field. It should be appreciated that the process may be applied to all of the bales located in the field, such that the map may show the location of all of the bales located in the field. The map may then be communicated to the retriever to enable more efficient retrieval of the bales in the field, without missing or failing to locate one or more of the bales.

In one aspect of the disclosure, the processor is operable to execute the bale mapping algorithm to calculate a retrieval sequence for retrieving multiple bales in the field. The controller may then communicate the retrieval sequence to the retriever. The retrieval sequence may be defined to provide the most efficient collection and/or retrieval of all of the bales in the field to minimize the time and cost of retrieval, as well as minimize the ground equipment movement over the field to minimize soil compaction.

A method of retrieving formed bales of crop material from a field is also provided. The method includes providing an aerial vehicle having an imaging device, a bale identifier, and a position locator. The aerial vehicle is flown over the field. An image of the field is captured with the imaging device. A bale in the captured image of the field is identified with the bale identifier. A location of the identified bale is determined with the position locator. The location of the bale may then be communicated to a retriever.

In one aspect of the disclosure, the aerial vehicle is an un-manned aerial vehicle. The method includes autonomously operating the un-manned aerial vehicle within a perimeter of the field. In other implementations, the aerial vehicle may be manually controlled by an operator, either remotely from the aerial vehicle or from the aerial vehicle. The aerial vehicle is maneuvered over the entire field to capture images of and identify all the bales located on the field.

In one aspect of the disclosure, the imaging device may include a camera having a lens that is positioned to face in a substantially downward vertical direction. The step of capturing the image of the field may further be defined as capturing the image of the field directly beneath the aerial vehicle.

In one aspect of the disclosure, the position locator may include a GPS receiver, and is operable to determine a position of the aerial vehicle at the time an image is captured. The step of determining a location of the identified bale with the position locator may further be defined as determining a position of the aerial vehicle with the position locator at the time the image is captured.

In one aspect of the disclosure, a map of the field is generated and communicated to the retriever. The map of the field may be generated to show the location of all of the bales identified in the field. The map of the field, including all of the bales located thereon, may then be used by an operator to locate and retrieve the bales. Alternatively, the map of the field, including all of the bales located therein, may be used as an input for a sequencing algorithm that develops an optimal retrieval sequence to minimize cost, time, and/or soil compaction during the retrieval process.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a field and a bale retrieval system.

FIG. 2 is a schematic elevation view of an aerial vehicle.

FIG. 3 is a schematic plan view of a field showing a plurality of bales.

FIG. 4 is a schematic plane view of the field shown in FIG. 3 showing an image including multiple bales included therein.

FIG. 5 is a schematic plan view of a map showing the location of a plurality of bales located thereon.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “substantially” or “approximately” are understood by those of ordinary skill to refer to reasonable ranges outside of the given value, for example, general tolerances associated with manufacturing, assembly, and use of the described embodiments.

Referring to the Figures, wherein like numerals indicate like parts throughout the several views, a bale retrieval system is generally shown at 20. The bale retrieval system 20 is operable to at least identify and locate one or more bales 22 of crop material, e.g., hay, straw or the like, within a field 24, and communicate the location of the bales 22 in the field 24 to a retriever 26.

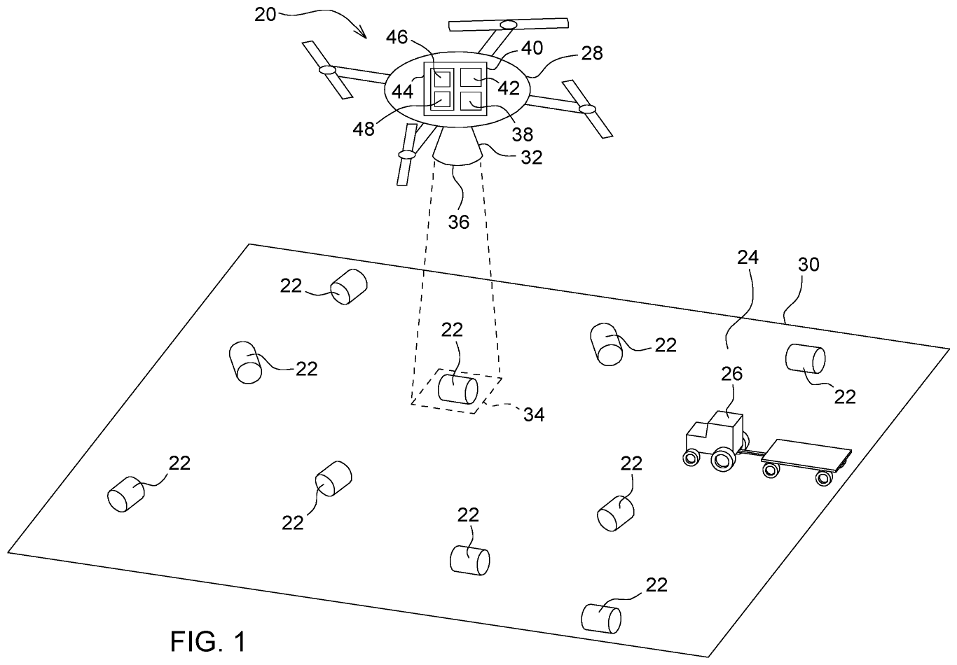

Referring to FIG. 1, the bale retrieval system 20 includes an aerial vehicle 28. The aerial vehicle 28 is operable to fly or otherwise move over a field 24 at a distance spaced vertically above the field 24. The aerial vehicle 28 may include, but is not limited to a manned aerial vehicle 28, an un-manned aerial vehicle 28, a satellite, or some other device capable of moving over the field 24. For example, the aerial vehicle 28 may include a remote-controlled drone, an autonomously operated drone, a helicopter, an airplane, a satellite, or some other similar vehicle.

In one implementation, the aerial vehicle 28 is an un-manned aerial vehicle 28 configured to operate autonomously within a perimeter 30 of the field 24. In another implementation, the aerial vehicle 28 is an un-manned aerial vehicle 28 controlled remotely by an operator. It should be appreciated that the aerial vehicle 28 may include one or more sensors, processors 42, controllers 40, algorithms, etc., necessary for control and operation of the aerial vehicle 28. The specific manner in which the aerial vehicle 28 is controlled and maneuvered over the field 24, and the specific components and features of the aerial vehicle 28 required for control and operation of the aerial vehicle 28 are understood by those skilled in the art, are not pertinent to the teachings of this disclosure, and are therefore not described in detail herein.

The aerial vehicle 28 includes an imaging device 32. The imaging device 32 is mounted on the aerial vehicle 28 and is operable to capture an image 34 of the field 24. The imaging device 32 may be positioned to face in a substantially downward vertical direction. In one implementation, the imaging device 32 includes a camera having a lens 36 positioned to face in a substantially downward vertical direction facing toward the field 24. The imaging device 32 may include a video camera, a still camera, or some other device capable of capturing an image 34.

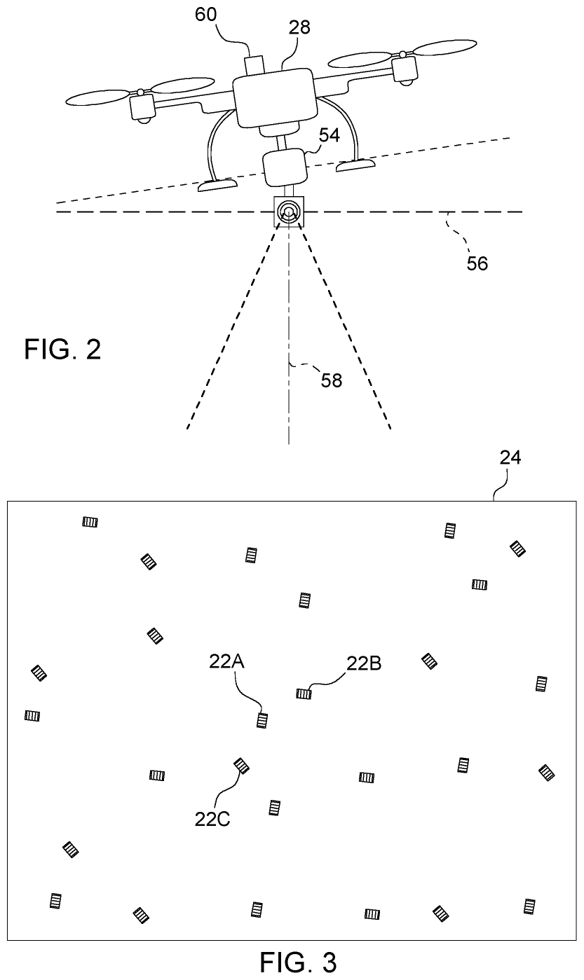

Referring to FIG. 2, the imaging device 32 may be mounted to the aerial vehicle 28 via a gimbal 54. As is understood by those in the art, the gimbal 54 is a device that enables the imaging device 32 to maintain a constant vertical downward orientation relative to gravity regardless of the orientation of the aerial vehicle 28. As such, as the aerial vehicle 28 tilts, angles, or inclines relative to a horizontal plane 56, the gimbal 54 will keep the imaging device 32 orientated in a vertical direction 58. The aerial vehicle 28 may include one or more sensors 60, e.g., an inertia sensor, a level sensor, etc., capable of detecting the orientation of the aerial vehicle 32. The sensors 60 may communicate their respective signals indicating the orientation of the aerial vehicle to a controller, which may control the gimbal 54 to properly position or orient the imaging device 32 in the downward vertical direction 58. If the aerial vehicle 28 is not equipped with the gimbal 54, then the controller 40 may log the inertial data from the sensors 60 at the time each image is captured, and use the inertial data, in combination with a position locater 38 described below, to calculate the location of the identified bales. 22.

The bale retrieval system 20 further includes the position locater 38. The position locator 38 may be disposed on and integral with the aerial vehicle 28, or may be located remote from the aerial vehicle 28. The position locator 38 is operable to determine a position on the field 24. In one implementation, the position locator 38 is mounted to the aerial vehicle 28 and is operable to determine a location of the aerial vehicle 28 over the field 24 at the time the imaging device 32 captures an image 34 of the field 24. As such, it should be appreciated that if the aerial vehicle 28 is positioned directly overhead of a bale 22 on the field 24, then the location of the aerial vehicle 28 at the time the image 34 including the bale 22 is captured by the imaging device 32 substantially corresponds to the position of the bale 22 in the field 24. In other implementations, the position locator 38 is operable to determine a position or location on the field 24, such as the location of a fixed marker or locating beacon.

In one implementation, the position locator 38 includes a Global Positioning Satellite (GPS) system. As understood by those skilled in the art, the GPS system receives a signal from multiple satellites, and calculates a position using the signals from the multiple satellites. It should be appreciated that the aerial vehicle 28 may include all sensors, computers, processors 42, algorithms, etc., necessary for the position locator 38, e.g., the GPS system, to calculate or otherwise determine the location of the aerial vehicle 28 at the time the imaging device 32 captures an image 34.

As noted above, the aerial vehicle 28 may be configured to operate autonomously within the perimeter 30 of the field 24. The aerial vehicle 28 moves across the field 24 to identify and locate all bales 22 located within the perimeter 30 of the field 24. In order to do so, the aerial vehicle 28 may include a controller 40 disposed in communication with the imaging device 32 and the position locater. The controller 40 may alternatively be referred to as a computing device, a computer, a module, a control module, a control unit, etc. The controller 40 is operable to identify and locate bales 22 disposed on the field 24. The controller 40 includes a processor 42, a memory 44, and all software, hardware, algorithms, connections, sensors, etc., necessary to identify and locate the bales 22 on the field 24. As such, a method may be embodied as a program or algorithm operable on the controller 40. It should be appreciated that the controller 40 may include any device capable of analyzing data from various sensors, comparing data, and making the necessary decisions and execute tasks required to identify and locate the bales 22 on the field 24.

The controller 40 may be embodied as one or multiple digital computers or host machines each having one or more processors 42, read only memory (ROM), random access memory (RAM), electrically-programmable read only memory (EPROM), optical drives, magnetic drives, etc., a high-speed clock, analog-to-digital (ND) circuitry, digital-to-analog (D/A) circuitry, and any required input/output (I/O) circuitry, I/O devices, and communication interfaces, as well as signal conditioning and buffer electronics.

The computer-readable memory 44 may include any non-transitory/tangible medium which participates in providing data or computer-readable instructions. The memory 44 may be non-volatile or volatile. Non-volatile media may include, for example, optical or magnetic disks and other persistent memory. Example volatile media may include dynamic random access memory (DRAM), which may constitute a main memory. Other examples of embodiments for the memory 44 include but are not limited to a floppy, flexible disk, or hard disk, magnetic tape or other magnetic medium, a CD-ROM, DVD, and/or any other optical medium, as well as other possible memory devices such as flash memory.

As noted above, the controller 40 includes the tangible, non-transitory memory 44 on which are recorded computer-executable instructions, including a bale mapping algorithm 46. The processor 42 of the controller 40 is configured for executing the bale mapping algorithm 46. The bale mapping algorithm 46 implements a method of retrieving formed bales 22 of crop material from the field 24.

The bale retrieval system 20 may further include a bale identifier 48. The bale identifier 48 may include, but is not limited to, a program or algorithm operable on the controller 40. The bale identifier 48 is operable to identify a bale 22 in an image 34 captured by the imaging device 32. The bale identifier 48 may include, but is not limited to, artificial intelligence and/or object recognition algorithms that enable the bale identifier 48 to identify one or more different shapes and/or sizes of baled crop material, from images 34 taken from different perspectives. For example, the bale identifier 48 may be programmed with multiple images 34 of different shapes and sizes of bales 22, from different perspectives, which may be used to identify bales 22 in the captured images 34. Object recognition software is understood by those skilled in the art. The specific manner in which the bale identifier 48 recognizes and/or determines that objects in the captured images 34 are bales 22 of crop material is not pertinent to the teachings of this disclosure, are known to those skilled in the art, and are therefore not described in detail herein.

The method of retrieving the formed bales 22 of crop material from the field 24 includes providing the aerial vehicle 28 with the imaging device 32 mounted thereon, as well as the bale identifier 48, and the position locator 38. As noted above, the bale identifier 48 and/or the position locator 38 may be mounted to and/or disposed on the aerial vehicle 28 with the controller 40, or may be remotely located from the aerial vehicle 28. For example, in one implementation, the aerial vehicle 28 includes the imaging device 32 and the controller 40 mounted thereon, with the controller 40 including the bale identifier 48 and the position locator 38. In another implementation, the aerial vehicle 28 includes the imaging device 32 and is disposed in communication with the controller 40, which may be located remotely from the aerial vehicle 28. The bale identifier 48 and the position locator 38 may be integral with or remote from the controller 40, with the imaging device 32 communicating the captured images 34 to the controller 40, and the controller 40 then using the bale identifier 48 and the position locator 38 to identify and locate the bales 22 on the field 24. It should be appreciated that other configurations of the bale retrieval system 20 not specifically described herein are possible.

The aerial vehicle 28 is then moved over the field 24. In one implementation the aerial vehicle 28 is flown of the field 24. The aerial vehicle 28 may be manually controlled to move over the field 24, or may move over the field 24 autonomously. In another implementation, the aerial vehicle 28 may follow a pre-programmed path to move over the field 24. The aerial vehicle 28 moves over the field 24 within the perimeter 30 of the field 24. The perimeter 30 may be learned by the bale mapping algorithm 46, such as by identifying tree lines, fence lines, roads, etc. In other implementations, the perimeter 30 of the field 24 may be pre-defined and/or entered into the memory 44 of the controller 40 prior to moving the aerial vehicle 28 over the field 24.

The aerial vehicle 28 captures one or more images 34 of the field 24 with the imaging device 32 as the aerial vehicle 28 moves over the field 24. In one implementation, the aerial vehicle 28 captures the image 34 of the field 24 directly beneath the aerial vehicle 28, such that the aerial vehicle 28 is located directly above the location of the captured image 34 in the field 24 at the time the image 34 is captured. As noted above, the image 34 may include a still image 34, or a video image 34.

Once the image 34 has been captured, the controller 40 identifies all formed bales 22 of crop material included in the image 34 with the bale identifier 48. As described above, the bale identifier 48 may use object recognition technology to identify the bales 22 of crop material in the field 24. The use and operation of object recognition technology is understood by those skilled in the art, and is therefore not described in detail herein.

Once the bale mapping algorithm 46 has identified a bales 22 in the captured image 34, then the bale mapping algorithm 46 determines a location of the identified bales 22 in the field 24 with the position locator 38. The location of each identified bale 22 may be described, for example, using latitude and longitude coordinates. However, it should be appreciated that the location of each identified bale 22 may be described using some other coordinate system.

The position locator 38 may determine the location of the bale 22 identified in the image 34 in a suitable manner. For example, in one implementation, the position locator 38 includes the GPS system mounted on the aerial vehicle 28. As is understood by those skilled in the art, the GPS system is capable of determine a location of the aerial vehicle 28. The position locator 38 may determine the location of the aerial vehicle 28 at the moment the image 34 is captured. If the imaging device 32 is configured to capture the image 34 directly beneath the aerial vehicle 28, and the position locator 38 is configured to determine the location of the aerial vehicle 28 at the time the image 34 is captured, then the position of the aerial vehicle 28 over the field 24 will approximate the position of the bale 22 included in the image 34 of the field 24. As such, the position of the aerial vehicle 28 may be used to determine the location of the bale 22 identified in the captured image 34.

In another implementation, the bale retrieval system 20 may position or orient the image 34 relative to a mapping coordinate system, such that positions within the image 34 are then correlated to the mapping coordinate system. The location of the identified bales 22 in the image 34 may then be determined based on their relative position within the image 34. It should be appreciated that the position of the identified bales 22 in the image 34 may be determined in some other manner than described herein.

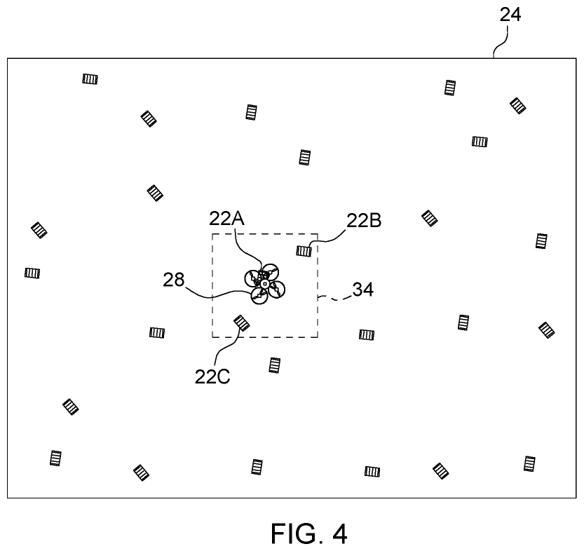

Referring to FIG. 3, a field 24 having a first bale 22A, a second bale 22B, and a third bale 22C is generally shown. Referring to FIG. 4, the aerial vehicle 28 is shown located directly over the first bale 22A when the imaging device 32 captures the image 34. The image 34 includes the first bale 22A, the second bale 22B, and the third bale 22C. Because the aerial device 28 is located directly over the first bale 22A, the location of the aerial device 28 over the field 24 correlates to the location of the first bale 22A, as described above. In addition, the location of the second bale 22B and the third bale 22C may further be determined by trigonometry using the location of the aerial vehicle 28, the pixel location of second and third bales 22B, 22C in the image 34, and the height of the aerial vehicle 28 over the field 34.

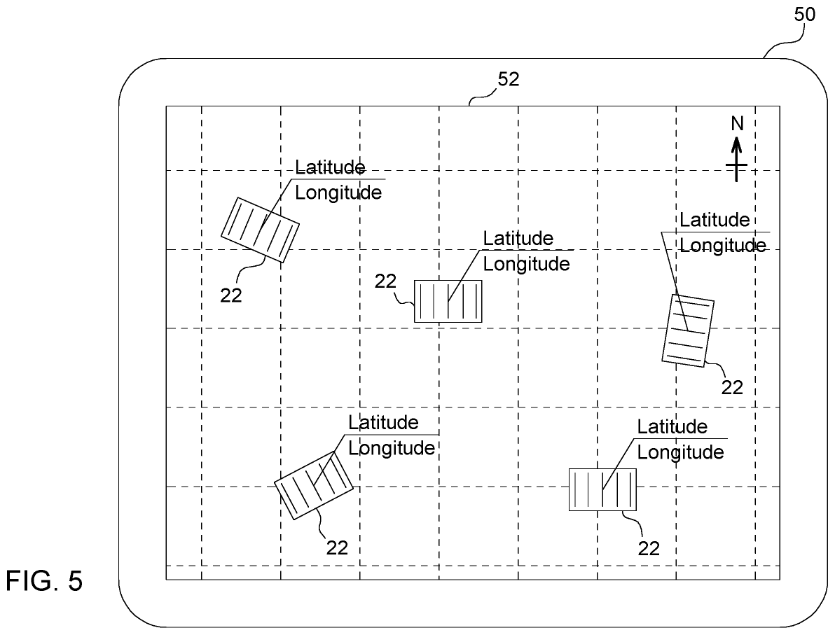

Referring to FIG. 5, once the locations of the bales 22 identified in the captured image(s) 34 are determined, the bale mapping algorithm 46 may generate a map 52 of the field 24 showing or otherwise indicating the location of the bales 22 thereon. The bale mapping algorithm 46 may then communicate the map 52 of the field 24, including the bales 22 shown thereon, to the retriever 26. The retriever 26 may include, but is not limited to any vehicle and/or piece of equipment capable of traversing through the field 24 and collecting/relocating the bales 22. For example, the retriever 26 may include an agricultural tractor with a bale picking/hauling attachment, etc. The retriever 26 may include a display screen 50 allowing an operator to view the map 52 of the field 24 showing the location of the bales 22 relative to the location of the retriever 26.

In other implementations, the bale mapping algorithm 46 need not generate the map of the field 24 showing the location of the bales 22 thereon. Instead, the bale mapping algorithm 46 may communicate the location of the bales 22 to the retriever 26. The location of the bales 22 may include, for example, a list of the geo-coordinates of each bale 22 on the field 24. The retriever 26 may then use the list of the geo-coordinates of each bale 22 to collect the bales 22. In one implementation, the retriever 26 is an autonomous vehicle that automatically collects the bales 22 using the locations of the bales 22 communicated from the bale mapping algorithm 46.

In another implementation, the bale mapping algorithm 46, or some other computing device, may use the locations of the bales 22 in the field 24 to calculate a retrieval sequence for retrieving multiple bales 22 in the field 24. The retrieval sequence may be communicated to the retriever 26 so that the retriever 26 may collect the bales 22 in the field 24 following the retrieval sequence. The retrieval sequence may include a defined sequence for gathering the bales 22 in the field 24. The retrieval sequence may be defined based on any desired retrieval characteristic. For example, the retrieval sequence may be defined to minimize a collection time, minimize travel over the field 24, collect bales 22 of similar quality, etc. The retrieval sequence may be defined using a algorithm operable to plan routes based on desired criteria, such as is known in the art.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A bale retrieval system comprising:
an aerial vehicle operable to fly over a field;
an imaging device mounted on the aerial vehicle and operable to capture an image of the field;
a position locater operable to determine a position on the field;
a controller in communication with the imaging device and the position locater, the controller including a processor and a memory having a bale mapping algorithm stored thereon, wherein the processor is operable to execute the bale mapping algorithm to:
identify a bale included in an image captured by the imaging device;
determine a location of the bale identified in the image with the position locator; and
communicate the location of the bale in the field to a bale retriever.

2. The bale retrieval system set forth in claim 1, wherein the aerial vehicle is one of a manned aerial vehicle, an un-manned aerial vehicle, or a satellite.

3. The bale retrieval system set forth in claim 1, wherein the imaging device is positioned to face in a substantially downward vertical direction.

4. The bale retrieval system set forth in claim 3, wherein the aerial vehicle includes a gimbal supporting the imaging device.

5. The bale retrieval system set forth in claim 3, wherein the position locator is mounted to the aerial vehicle and is operable to determine a location of the aerial vehicle over the field such that the location of the aerial vehicle at the time the image including the bale is captured substantially corresponds to the position of the bale in the field.

6. The bale retrieval system set forth in claim 1, wherein the processor is operable to execute the bale mapping algorithm to generate a map of the field, wherein the map of the field indicates the location of the bale in the field.

7. The bale retrieval system set forth in claim 1, wherein the processor is operable to execute the bale mapping algorithm to calculate a retrieval sequence for retrieving multiple bales in the field, and communicate the retrieval sequence to the retriever.

8. The bale retrieval system set forth in claim 1, wherein the aerial vehicle is configured to operate autonomously within a perimeter of the field to identify and locate all bales located within the perimeter of the field.

9. The bale retrieval system set forth in claim 1, wherein the imaging device includes a camera.

10. The bale retrieval system set forth in claim 1, wherein the position locator includes a Global Positioning Satellite (GPS) system.

11. A bale retrieval system comprising:
an un-manned aerial vehicle operable to fly over a field;
an camera mounted on the un-manned aerial vehicle and operable to capture an image of the field;
a GPS receiver mounted on the un-manned aerial vehicle and operable to determine a position of the un-manned aerial vehicle over the field at the time the imaging device captures an image;
a controller in communication with the camera and the GPS receiver, the controller including a processor and a memory having a bale mapping algorithm stored thereon, wherein the processor is operable to execute the bale mapping algorithm to:
identify a bale included in an image captured by the camera;
determine a location of the bale identified in the image with the GPS receiver; and
communicate the location of the bale in the field to a bale retriever.

12. The bale retrieval system set forth in claim 11, wherein the camera includes a lens positioned to face in a substantially downward vertical direction.

13. The bale retrieval system set forth in claim 11, wherein the un-manned aerial vehicle includes a gimbal supporting the camera.

14. The bale retrieval system set forth in claim 11, wherein the processor is operable to execute the bale mapping algorithm to generate a map of the field, wherein the map of the field indicates the location of the bale in the field.

15. The bale retrieval system set forth in claim 11, wherein the processor is operable to execute the bale mapping algorithm to calculate a retrieval sequence for retrieving multiple bales in the field, and communicate the retrieval sequence to the retriever.

16. The bale retrieval system set forth in claim 11, wherein the un-manned aerial vehicle is configured to operate autonomously within a perimeter of the field to identify and locate all bales located within the perimeter of the field.

17. A method of retrieving formed bales of crop material from a field, the method comprising:
providing an aerial vehicle having an imaging device, a bale identifier, and a position locator;
flying the aerial vehicle over the field;
capturing an image of the field, with the imaging device;
identifying a bale in the captured image of the field, with the bale identifier;
determining a location of the identified bale with the position locator; and
communicating the location of the bale to a retriever.

18. The method set forth in claim 17, wherein the imaging device is positioned to face and maintain a substantially downward vertical direction, and wherein capturing the image of the field is further defined as capturing the image of the field directly beneath the aerial vehicle.

19. The method set forth in claim 17, wherein the position locator is operable to determine a position of the aerial vehicle at the time the image is captured, and wherein determining a location of the identified bale with the position locator is further defined as determining a position of the aerial vehicle with the position locator at the time the image is captured.

20. The method set forth in claim 17, further comprising generating a map of the field showing the location of the bale thereon, and communicating the map of the field to the retriever.
